(19) United States
(12) Patent Application Publication
(10) Pub. No.: US 2021/0402421 A1
(43) Pub. Date: Dec. 30, 2021

(54) FLUIDIC OSCILLATOR FOR A SWIMMING POOL AND SPA

(71) Applicant: San Juan Patents, Inc., Lakeland, FL (US)

(72) Inventor: Kirk Sullivan, Lakeland, FL (US)

(21) Appl. No.: 17/355,141

(22) Filed: Jun. 22, 2021

Related U.S. Application Data
(60) Provisional application No. 63/044,465, filed on Jun. 26, 2020.

(51) Int. Cl. B05B 1/08; B05B 1/34; E04H 4/14

(52) U.S. Cl. CPC B05B 1/08; E04H 4/14; B05B 1/3405

(57) ABSTRACT

A fluidic oscillator includes an inlet portion configured to be engageable with a source of pressurized fluid. An oscillating portion is coupled to the inlet portion and includes a central chamber, a pair of side passageways in fluid communication with the central chamber, and an outlet disposed about a central axis. The pair of side passageways are positioned on opposite sides of the central axis, with each side passageway having a feedback inlet that receives fluid from the central passageway and a feedback outlet that returns fluid to the central passageway, with the feedback outlet being positioned between the feedback inlet and the inlet portion. The oscillating portion is configured such that, fluid fills the pair of side passageways in an alternating sequence, which results in fluid exiting the outlet at varying angles relative to the central axis.

### CROSS-REFERENCE TO RELATED APPLICATIONS

This application claims the benefit of U.S. Provisional Application No. 63/044,465, filed Jun. 26, 2020, the contents of which are expressly incorporated herein by reference.

### STATEMENT RE: FEDERALLY SPONSORED RESEARCH/DEVELOPMENT

Not Applicable

### BACKGROUND

### 1. Technical Field

The present disclosure relates generally to an oscillating or pulsating jet for a swimming pool or spa, and more specifically, to a fluidic oscillator capable of facilitating the oscillating or pulsating characteristic via fluid pressure and without moving parts within the fluidic oscillator.

### 2. Description of the Related Art

A critical aspect to maintaining a healthy swimming pool is to create proper water circulation within the swimming pool. Water circulation may improve dispersing of chemicals within the pool to maintain chemical balance. Circulation of water may also help to move debris toward a filter to remove debris from the water. Thus, proper water circulation may help protect against issues such as cloudy water or algae blooms within the pool water.

To facilitate water circulation within a pool or spa, one car more return jets may be used to deliver water under pressure into the pool or spa. A commonly used return jet is a directional eyeball jet located on one or more walls of the pool and which may include an outer housing, and an internal body that is moveable relative to the outer housing. The internal body may include an outlet opening that may be aimed via movement of the internal body relative to the outer housing to achieve fluid flow in a particular direction.

Although conventional return jets, such as directional eyeballs, may be useful for facilitating fluid flow within a pool or spa, such conventional return jets may be associated with several deficiencies. A significant deficiency is that the conventional return jets may include moving components, such as the internal body of an eyeball jet. The internal components may result in a more difficult manufacturing process, as well as limiting the lifespan of the conventional return jet. Along these lines, should either one of the outer housing or the internal body crack or break, the entire device may be compromised and require replacement. Another deficiency of many conventional return jets is that they may be limited in their ability to direct pressurized water over a wide distribution area. In this regard, although the directional eyeballs may be adjustable over a prescribed distribution area, the water emitted from the eyeballs may be along a single axis, rather than a distribution area or distribution cone. As such, the amount of water that is circulated by the jet may be limited, which may reduce the effectiveness of the directional eyeball.

Accordingly, there is a need in the art for a return jet for a pool or spa that does not include moving parts, and yet, is capable of delivery pressurized water over a wide distribution area. Various aspects of the present disclosure address this particular need, as will be discussed in more detail below.

### BRIEF SUMMARY

In accordance with one embodiment of the present disclosure, there is provided a fluidic oscillator that may be configured to output a jet of pressurized fluid in an oscillating fashion. In this regard, the angle of the axis along which the pressurized fluid is emitted may constantly vary relative to a fixed central axis. The fluidic oscillator may be configured to generate the oscillating output independent of any moving components. The fluidic oscillator may be used in a pool or spa for improving water circulation therein.

According to one embodiment, there is provided a fluidic oscillator for use with a source of pressurized fluid, the fluidic oscillator includes an inlet portion configured to be engageable with the source of pressurized fluid. The inlet portion includes a side wall and a recessed wall connected to the side wall, with the recessed wall having an opening extending therethrough. The fluidic oscillator additionally includes an oscillating portion coupled to the inlet portion. The oscillating portion includes a central chamber in fluid communication with the opening of the inlet portion, a pair of side passageways in fluid communication with the central chamber, and an outlet disposed about a central axis. The pair of side passageways are positioned on opposite sides of the central axis, with each side passageway having a feedback inlet that receives fluid from the central passageway and a feedback outlet that returns fluid to the central passageway, with the feedback outlet being positioned between the feedback inlet and the inlet portion. The oscillating portion is configured such that fluid fills the pair of side passageways in an alternating sequence, which results in fluid exiting the outlet at varying angles relative to the central axis.

The recessed wall may include an upstream surface and an opposing downstream surface, and the opening may be tapered such that a cross section of the opening at the upstream surface is larger than the cross section of the opening at the downstream surface, The fluidic oscillator may additionally include a tapered passageway extending between the opening and the central chamber.

The fluidic oscillator may further comprise a pair of dividing walls, with each dividing wall being positioned between the central chamber and a respective one of the pair of side passageways. Each dividing wall may include a medial surface and a lateral surface, with the medial surface facing the central chamber and including a linear portion and a concave portion. Each lateral surface may include a linear portion and a convex portion.

Each side passageway may include a linear segment and an arcuate segment.

The oscillating portion may be configured such that fluid flows through the central chamber prior to flowing through one of the pair of side passageways.

The outlet may be tapered such that a cross section of the outlet increases in a direction away from the central chamber.

The inlet portion may include a threaded connector configured to facilitate threaded engagement with a fluid source.

According to another embodiment, there is provided a pulsating oscillator for use with a source of pressurized fluid. The pulsating oscillator includes an inlet portion configured to be engageable with the source of pressurized fluid. The inlet portion includes a side wall and a recessed wall connected to the side wall, with the recessed wall having an opening extending therethrough. The fluidic oscillator additionally includes an oscillating portion coupled to the inlet portion. The oscillating portion includes a central chamber in fluid communication with the opening of the inlet portion, a pair of side passageways in fluid communication with the central chamber, and an outlet disposed about a central axis. The pair of side passageways are positioned on opposite sides of the central axis, with each side passageway having a feedback inlet that receives fluid from the central passageway and a feedback outlet that returns fluid to the central passageway, with the feedback outlet being positioned between the feedback inlet and the inlet portion. The oscillating portion is configured such that fluid fills the pair of side passageways in an alternating sequence, which results in fluid exiting the outlet at varying angles relative to the central axis. The pulsating oscillator further includes a pulsating portion coupled to the oscillating portion. The pulsating portion includes a pair of outlet passageway's in fluid communication with the outlet of the oscillating portion. The pair of outlet passageway's are configured to receive fluid from the outlet in an alternating sequence and emit fluid therefrom an in a pulsating fashion.

A vortex generator for use with a source of pressurized fluid. The vortex generator includes a cylindrical body having a pair of opposed faces, with the cylindrical body having a plurality of passageways extending therethrough. Each passageway includes a pair of openings on respective ones of the pair of opposed faces. One of the pair of openings having a smaller diameter than the other of the pair of openings,

According to another embodiment, there is provided a vortex generator for use with a source of pressurized fluid. The vortex generator includes a cylindrical body having a pair of opposed faces and a plurality of passageways extending therethrough. Each passageway includes a pair of openings on respective ones of the pair of opposed faces, with one of the pair of openings having a smaller diameter than the other of the pair of openings. The cylindrical body additionally includes at least one fluidic oscillator cavity including a central chamber in fluid communication with an inlet portion, a pair of side passageways in fluid communication with the central chamber, and an outlet disposed about a central axis. The pair of side passageways are positioned on opposite sides of the central axis, with each side passageway having a feedback inlet that receives fluid from the central passageway and a feedback outlet that returns fluid to the central passageway. The feedback outlet is positioned between the feedback inlet and the inlet portion. The oscillating portion is configured such that fluid fills the pair of side passageways in an alternating sequence, which results in fluid exiting the outlet at varying angles relative to the central axis.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is an enlarged lower, front perspective view of a first embodiment of a fluidic oscillator for a pool;

FIG. 2 is a rear perspective view of the fluidic oscillator of FIG. 1;

FIG. 3 is another rear perspective view of the fluidic oscillator of FIG. 1, taken from a different angle from that of FIG. 2;

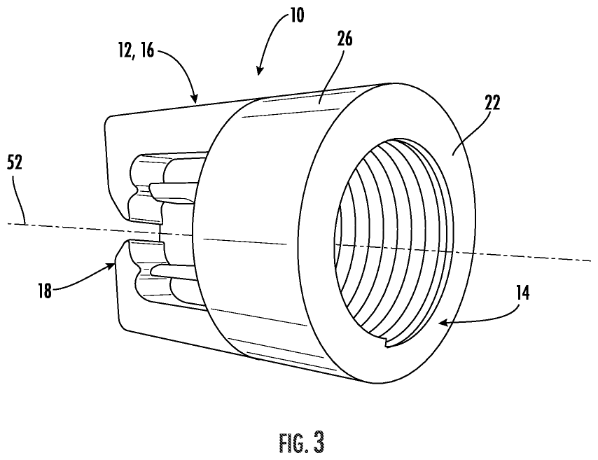

FIG. 4 is a side perspective view of a the fluidic oscillator;

FIG. 5 is a front perspective view of the fluidic oscillator depicted in FIG. 4;

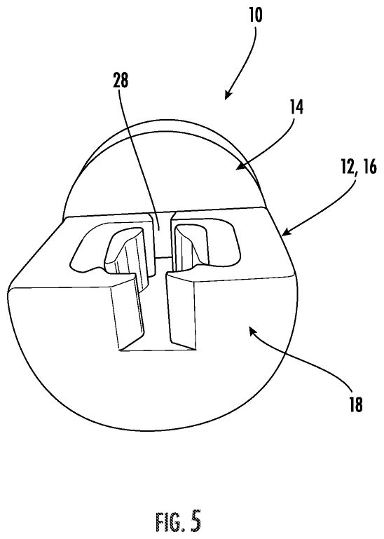

FIG. 6 depicts an exemplary fluid flow through the fluidic oscillator;

FIG. 7 is a side perspective view of an embodiment of a pulsating fluidic oscillator;

FIG. 8 is a rear perspective view of the pulsating fluidic oscillator of FIG. 7;

FIG. 9 is a side perspective view of a pulsating fluidic oscillator;

FIG. 10 is front view of a vortex oscillator;

FIG. 11 is a rear view of the vortex oscillator of FIG. 10; and

FIG. 12 is a cross sectional view of one embodiment of the vortex oscillator.

Common reference numerals are used throughout the drawings and the detailed description to indicate the same elements.

### DETAILED DESCRIPTION

The detailed description set forth below in connection with the appended drawings is intended as a description of certain embodiments of a fluidic oscillator and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

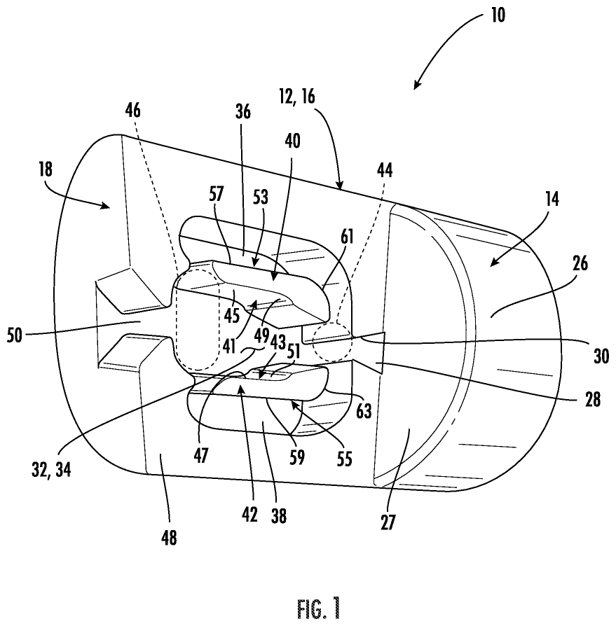

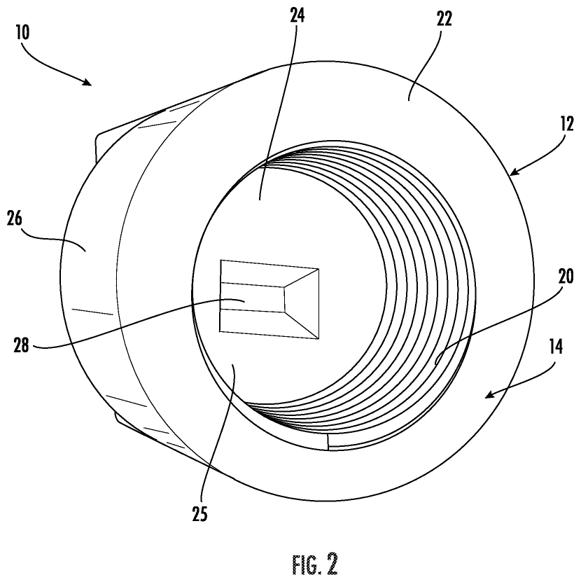

Referring now to FIGS. 1 and 2, there is depicted a first embodiment of a fluidic oscillator 10 for a swimming pool, spa, or tub. The fluidic oscillator 10 is configured to receive fluid from a pressurized fluid source, e.g., a residential water line, and emit an oscillating or variable direction output to create a desired disturbance or mixing of the water. The fluidic oscillator 10 may be configured to generate the oscillating motion of the output by creating prescribed internal fluid flow characteristics produced by specific internal contours and passageways of the fluidic oscillator 10. As the pressurized fluid flows through the fluidic oscillator 10, the internal contours of the fluidic oscillator 10 create internal flow characteristics which produce an oscillating output flow. Therefore, the fluidic oscillator 10 may be configured to generate the oscillations without any moving parts.

The fluidic oscillator 10 includes a body 12 having an inlet end portion 14, an intermediate portion 16, and an outlet end portion 18. The inlet end portion 14 may be configured to attach to a conduit or hose that may deliver water to the fluidic oscillator 10 under pressure. The inlet end portion 14 may include an internally threaded female connector 20 that may be connected to a corresponding externally threaded male connector. It is contemplated that in other embodiments, the configuration may be reversed, such that the inlet end portion 14 of the fluidic oscillator 10 may include the externally threaded male connector that engages with an internally threaded female connector. Other connectors known in the art, such as push-to-connect fittings, etc., may also be used without departing from the spirit and scope of the present disclosure.

The inlet end portion 14 may include an inlet end surface 22 and a recessed wall 24 spaced from the inlet end surface 22. A cylindrical side wall 26 may extend between the inlet end surface 22 and the recessed wall 24 and include internal threads to define the female connector 20. The recessed wall 2.4 may include an upstream surface 25, an opposing downstream surface 27, and an opening 28 formed therethrough. In the exemplary embodiment, the opening 28 has a tapered profile, with the size of the opening 28 decreasing in the direction of flow, i.e., from the upstream surface 25 of the recessed wall 24 toward the downstream surface 27 of the recessed wall 24. The decreasing, tapered configuration may facilitate an increase in fluid pressure and flow speed as the fluid flows through the opening 28. In the exemplary embodiment, the tapered configuration is defined by an upper surface, a bottom surface and a pair of opposed side surfaces. It is also contemplated that the tapered configuration may be conical or frustoconical.

The intermediate portion 16 may extend between the inlet and outlet end portions 14, 18 and include a tapered passageway 30 that extends from the opening 28. The configuration of the taper associated with the tapered passageway 30 may be a continuation of the taper associated with the opening 28. The tapered passageway 30 may extend between the opening 28 and an internal primary chamber 32. The primary chamber 32 includes three main areas, namely, a central chamber 34, a first side passageway 36, and a second side passageway 38. Each side passageway 36, 38 may include a respective linear segment and a respective arcuate segment. The central chamber 34 is separated from portions of the first and second side passageways 36, 38 by respective first and second dividing walls 40, 42. Each dividing wall 40, 42 may include a medial surface 41, 43 having a linear portion 45, 47 and a concave portion 49, 51, and a lateral surface 53, 55 including a linear portion 57, 59 and a convex portion 61, 63.

The primary chamber 32 intersects with the first and second side passageways 36, 38 at two locations, namely a main chamber inlet 44 and a main chamber outlet 46. The main chamber outlet 46 may include a pair of arcuate or tapered walls that converge toward an outlet opening 50. The intermediate portion 16 may include a cover which is coupled to outer face 48 and extends over the primary chamber 32 to enclose the primary chamber 32. The cover may be clear or transparent, such as Plexiglass, although non-transparent covers may be used without departing from the spirit and scope of the present disclosure.

The outlet end portion 18 includes the outlet opening 50 to allow fluid to exit the fluidic oscillator 10. The outlet opening 50 may be tapered, with the size of the opening 50 increasing away from the intermediate portion 16 (e.g., increasing in the direction of flow). The tapered outlet opening 50 in the exemplary embodiment may be formed by a tapered upper surface, a tapered lower surface, and a pair of tapered side surfaces, however, other configurations known in the art may also be used. The tapered configuration may allow the fluid outlet to oscillate without obstruction by the fluidic oscillator 10.

With the basic structure of the fluidic oscillator 10 described above, the following discussion focuses on an exemplary fluid flow through the oscillator 10. Fluid under pressure enters the inlet end portion 14 and encounters a reduced volume as a result of the tapered configuration of the inlet end portion, particularly the tapered configuration of the opening 28. Accordingly, the fluid may undergo an increase in pressure and speed as the fluid passes through the inlet end portion 14.

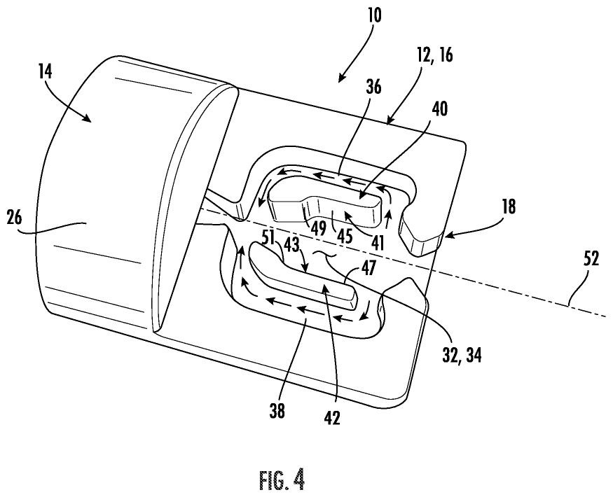

The fluid may then enter the primary chamber 32 and begin to fill the primary chamber 32. Due to the pressure of the fluid flow, and the presence of air bubbles, vortices, pressure imbalances, fluid friction, etc., the fluid may slightly deviate from a central axis 52, and toward one of the side passageways 36, 38. When the fluid is close enough to one of the side passageways 36, 38, the fluid stream may separate into a primary stream and a secondary stream. For purposes of this discussion, it is assumed that fluid will enter the first side passageway 36 and then the second side passageway 38; however, it is understood that fluid may initially flow through the second side passageway 38 first, and then the first side passageway 36. Furthermore, arrows have been included in FIG. 4 to show the direction of flow through the first and second passageways 36, 38.

The primary stream may continue through the outlet 50, while the secondary stream may enter the adjacent first side passageway 36. The secondary stream flows through the first side passageway 36, which directs the secondary stream back toward the main chamber inlet 44. As the secondary stream exits the first side passageway 36, the fluid flows into the central chamber 34 above the fluid entering the central chamber 34 from the inlet end portion 14 to create a pressure bubble or region above the incoming fluid, which urges the incoming fluid toward the second side passageway 38. When the primary stream moves toward the other side passageway, the process is repeated, with a portion of the fluid passing through the second side passageway 38 and creating a pressure bubble on the other side of the primary stream.

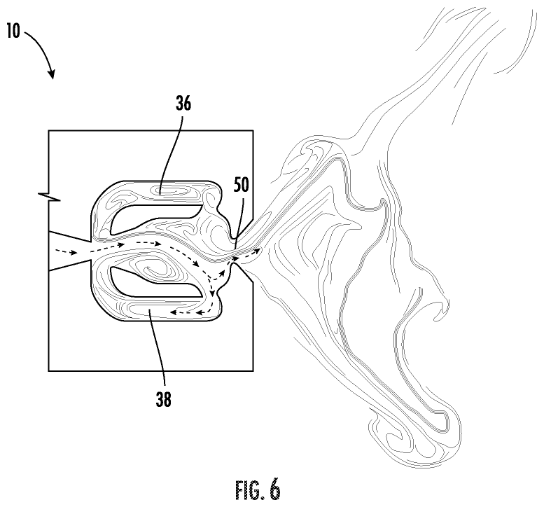

The cycle repeats itself, with the resulting outlet flow oscillating back and forth as the fluid exits the fluidic oscillator l0. The oscillations may be caused by the fluid alternating between filling a firs(side passageway 36 and then the second side passageway 38. FIG. 6 shows a snapshot of fluid flowing through a fluidic oscillator 10, with fluid within the central chamber 34 dividing into a flow through the outlet opening 50 and flow through the second side passageway 38.

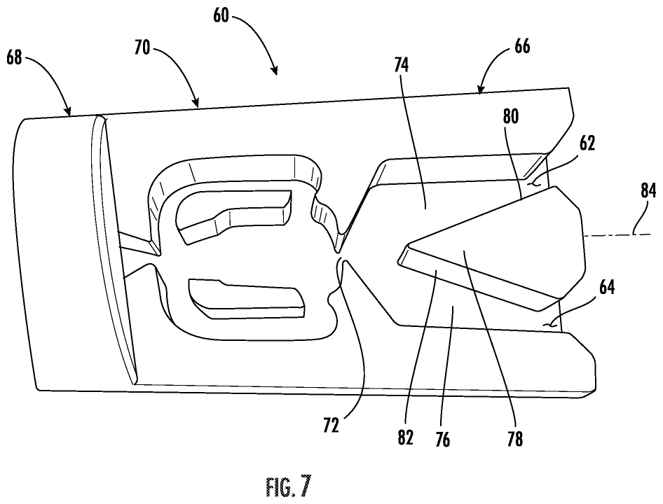

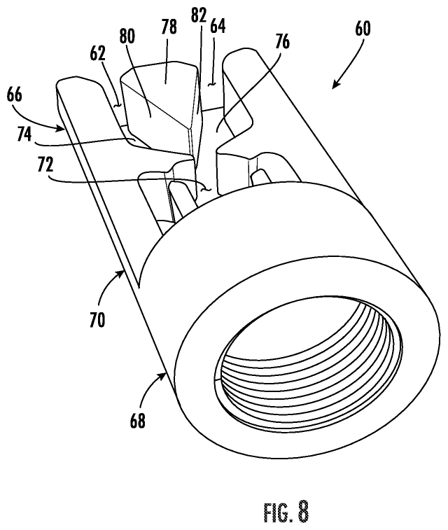

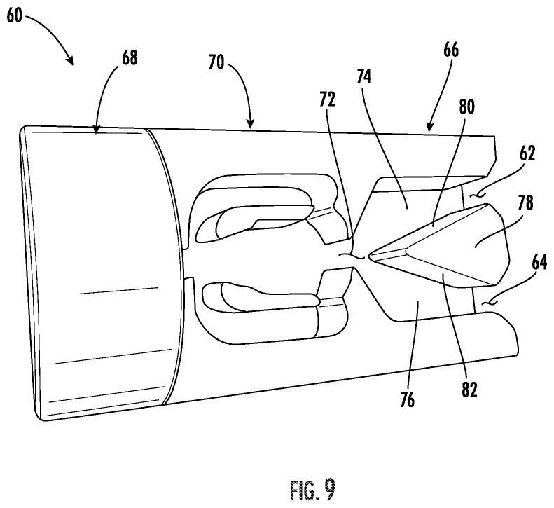

Referring now to FIGS. 7-9, there is depicted an embodiment of a pulsating fluidic oscillator 60 having a pair of outlet ports 62, 64. The pulsating fluidic oscillator 60 may be capable of outputting pressurized fluid in an alternating sequence, with pressurized fluid being discharged from a first outlet port 62, and then pressurized fluid being discharged from a second outlet port 64, with the alternating discharge continuing as long as pressurized fluid is received by the pulsating fluidic oscillator 60. The pulsating fluidic oscillator 60 is capable of creating the alternating discharge without the use of moving parts.

The pulsating fluidic oscillator 60 is similar to the fluidic oscillator 10 described above, with the primary difference being the addition of a pulsating output section 66. In this regard, the pulsating fluidic oscillator 60 includes an inlet end portion 68 and an intermediate portion 70 that is substantially similar or identical to that of the fluidic oscillator 10 described above. The pulsating output section 66 is downstream of an internal opening or passage, which fluidly connects the intermediate section 70 and the pulsating output section 66.

According to one embodiment, the pulsating output section 66 includes a pair of outlet passageways (e.g., a first outlet passageway 74 and a second outlet passageway 76) extending from the common internal opening 72. In this regard, fluid that enters the internal opening 72 passes through one of the outlet passageways 74, 76. The outlet passageways 74, 76 may be separated by dividing wall 78, that may have a first face 80 at least partially defining the first outlet passageway 74 and a second face 82 at least partially defining the second outlet passageway 76. The first and second faces 80, 82 may intersect at an apex at the junction of the first and second outlet passageways 74, 76. The first and second faces 80, 82 may extend from the apex at an angle relative to each other. At the end of each outlet passageway 4, 76 is an outlet port (e.g., first and second outlet ports 62, 64), which allow for alternating discharge of pressurized fluid into the ambient environment.

As explained in more detail above, due to the configuration of the intermediate section 70, fluid passing through the internal passage 72 oscillates with regard to a central axis 84. Accordingly, the oscillation will result in an alternating filling of the first and second outlet passageways 74, 76. In other words, during use, the direction of fluid exiting the internal passage 72 may be such that the first outlet passageway 74 is filled with fluid, which is then discharged through the first outlet port 62. Subsequently, the direction of fluid flowing through the internal passage 72 may change such that the second outlet passageway 76 is filled with fluid, which is then discharged through the second outlet port 64.

Whereas the fluidic oscillator 10 discharges a continuous jet stream that varies in flow direction, the pulsating fluidic oscillator 60 generates a pulsing output, which alternates between at least two outlet ports 62, 64. In this regard, the direction of flow through the respective ports 62, 64 may be substantially along respective, generally fixed discharge axes, e.g., the discharge from the first outlet port 62 may be along a first discharge axis and the discharge from the second outlet port 64 may be along a second discharge axis. The first and second discharge axes may be generally parallel to each other, angled toward each other, or angled away from each other, depending on the desired output flow characteristics.

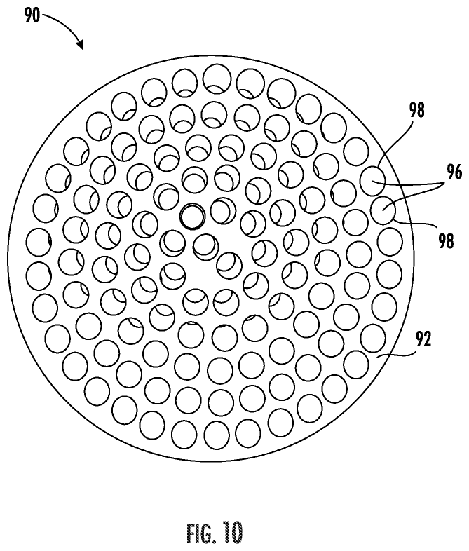

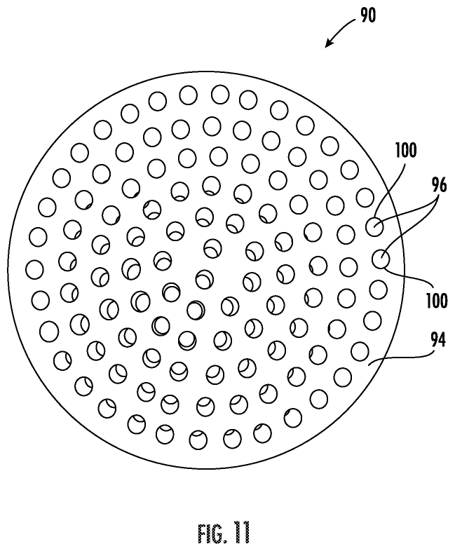

Referring now to FIGS. 10-12, there is depicted an embodiment of a vortex oscillator 90 configured to generate a vortex without any internal moving parts. Rather, the vortex(es) created by the vortex oscillator 90 may be generated as a result of pressurized fluid passing through a prescribed structure of the vortex oscillator 90. In the embodiment depicted in FIGS. 10-11, the vortex oscillator 90 is a disc having a pair of opposed faces 92, 94 to define a thickness therebetween. The disc includes a plurality of passageways 96 extending through the disc, with each passageway 96 having a wide opening 98 on one face 92 and a narrow opening 100 on another face 94.

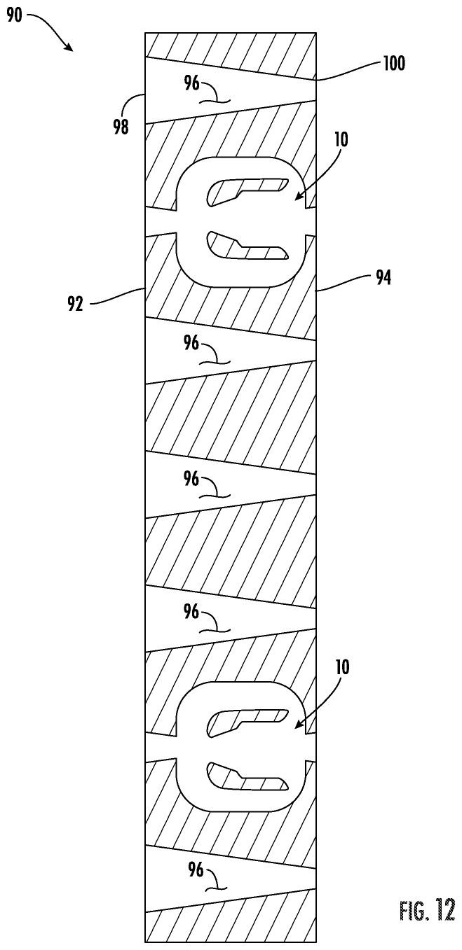

According to one embodiment, it is contemplated that four fluidic oscillator cavities may be set in a square (North, East, South, West) pattern embedded inside a copper disc. The fluidic oscillator cavities may be configured similar to the fluidic oscillator 10, or pulsating oscillator, discussed above 60. The remainder of the disc may have holes/passageways 96 that extend all the way through the disc, but are funnel or cone shaped, which causes the water to pass through a decreasing passageway. The configuration may cause the water to undergo a pressure drop, which may cause the water to super heat/boil for a nano second, which helps to sterilize the pool water. FIG. 12 is a cross sectional view of one exemplary embodiment of a disc-shaped vortex oscillator having an embedded cavity in the shape of fluidic oscillator 10 along with a plurality of tapered passageways 96.

The copper disk may be placed in the pool water flow downstream of a soft oxygen tee. The flow of water over and through the copper may shed natural beneficial copper ions into the water. The soft oxygen bubbles may become compressed into the pool water vortex and the four fluidic oscillators may sweep back and forth dispersing the micro/nano bubbles that are generated upstream.

The fluid characteristics generated or facilitated by the vortex oscillator 90 may be effectuated without the use of moving parts. In this regard, the fluid characteristics may be generated solely by the internal configuration of the vortex oscillator.

In one embodiment, the vortex oscillator 90 is configured to fit inside a 6″ section of clear PVC pipe, with unions on each side. Different sizes may fit inside 1.5″, 2″ or 3″ inner diameter pipe.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A fluidic oscillator for use with a source of pressurized fluid, the fluidic oscillator including:
an inlet portion configured to be engageable with the source of pressurized fluid, the inlet portion having a side wall and a recessed wall connected to the side wall, the recessed wall having an opening extending therethrough; and
an oscillating portion coupled to the inlet portion, the oscillating portion including a central chamber in fluid communication with the opening of the inlet portion, a pair of side passageways in fluid communication with the central chamber, and an outlet disposed about a central axis, the pair of side passageways being positioned on opposite sides of the central axis, with each side passageway having a feedback inlet that receives fluid from the central passageway and a feedback outlet that returns fluid to the central passageway, the feedback outlet being positioned between the feedback inlet and the inlet portion;
the oscillating portion being configured such that fluid fills the pair of side passageways in an alternating sequence, which results in fluid exiting the outlet at varying angles relative to the central axis.

2. The fluidic oscillator recited in claim 1 wherein the recessed wall includes an upstream surface and an opposing downstream surface, the opening being tapered such that a cross section of the opening at the upstream surface is larger than the cross section of the opening at the downstream surface.

3. The fluidic oscillator recited in claim 2, further comprising a tapered passageway extending between the opening and the central chamber.

4. The fluidic oscillator recited in claim 1, further comprising a pair of dividing walls, each dividing wall being positioned between the central chamber and a respective one of the pair of side passageways.

5. The fluidic oscillator recited in claim 4, wherein each dividing wall includes a medial surface and a lateral surface, the medial surface facing the central chamber and including a linear portion and a concave portion.

6. The fluidic oscillator recited in claim 5, wherein each lateral surface includes a linear portion and a convex portion.

7. The fluidic oscillator recited in claim 1, wherein each side passageway includes a linear segment and an arcuate segment.

8. The fluidic oscillator recited in claim 1, wherein the oscillating portion is configured such that fluid flows through the central chamber prior to flowing through one of the pair of side passageways.

9. The fluidic oscillator recited in claim 1, wherein the outlet is tapered such that a cross section of the outlet increases in a direction away from the central chamber.

10. The fluidic oscillator recited in claim 1, wherein the inlet portion includes a threaded connector configured to facilitate threaded engagement with a fluid source.

11. A pulsating oscillator for use with a source of pressurized fluid, the fluidic oscillator including:
an inlet portion configured to be engageable with the source of pressurized fluid, the inlet portion having a side wall and a recessed wall connected to the side wall, the recessed wall having an opening extending therethrough;
an oscillating portion coupled to the inlet portion, the oscillating portion including a central chamber in fluid communication with the opening of the inlet portion, a pair of side passageways in fluid communication with the central chamber, and an outlet disposed about a central axis, the pair of side passageways being positioned on opposite sides of the central axis, with each side passageway having a feedback inlet that receives fluid from the central passageway and a feedback outlet that returns fluid to the central passageway, the feedback outlet being positioned between the feedback inlet and the inlet portion, the oscillating portion being configured such that fluid fills the pair of side passageways in an alternating sequence, which results in fluid exiting the outlet at varying angles relative to the central axis; and
a pulsating portion coupled to the oscillating portion, the pulsating portion including a pair of outlet passageways in fluid communication with the outlet of the oscillating portion, the pair of outlet passageways being configured to receive fluid from the outlet in an alternating sequence and emit fluid therefrom an in a pulsating fashion.

12. The pulsating oscillator recited in claim 11, wherein the recessed wall includes an upstream surface and an opposing downstream surface, the opening being tapered such that a cross section of the opening at the upstream surface is larger than the cross section of the opening at the downstream surface.

13. The pulsating oscillator recited in claim 12, further comprising a tapered passageway extending between the opening and the central chamber.

14. The pulsating oscillator recited in claim 11, further comprising a pair of dividing walls, each dividing wall being positioned between the central chamber and a respective one of the pair of side passageways.

15. The pulsating oscillator recited in claim 14, wherein each dividing wall includes a medial surface and a lateral surface, the medial surface facing the central chamber and including a linear portion and a concave portion.

16. The pulsating oscillator recited in claim 15, wherein each lateral surface includes a linear portion and a convex portion.

17. The pulsating oscillator recited in claim 11, wherein each side passageway includes a linear segment and an arcuate segment.

18. The pulsating oscillator recited in claim 11, wherein the oscillating portion is configured such that fluid flows through the central chamber prior to flowing through one of the pair of side passageways.

19. The pulsating oscillator recited in claim 11, wherein the outlet is tapered such that a cross section of the outlet increases in a direction away from the central chamber.

20. A vortex generator for use with a source of pressurized fluid, the vortex generator including:
a cylindrical body having a pair of opposed faces, the cylindrical body having:
a plurality of passageways extending therethrough, each passageway having a pair of openings on respective ones of the pair of opposed faces, one of the pair of openings having a smaller diameter than the other of the pair of openings; and
at least one fluidic oscillator cavity including a central chamber in fluid communication with an inlet portion, a pair of side passageways in fluid communication with the central chamber, and an outlet disposed about a central axis, the pair of side passageways being positioned on opposite sides of the central axis, with each side passageway having a feedback inlet that receives fluid from the central passageway and a feedback outlet that returns fluid to the central passageway, the feedback outlet being positioned between the feedback inlet and the inlet portion;
the oscillating portion being configured such that fluid fills the pair of side passageways in an alternating sequence, which results in fluid exiting the outlet at varying angles relative to the central axis.
